(19) United States
(12) Patent Application Publication
(10) Pub. No.: US 2026/0050104 A1
(43) Pub. Date: Feb. 19, 2026

(54) WEATHER MEASUREMENT INSTRUMENT SENSOR

(71) Applicant: Primex Wireless, Inc., Lake Geneva, WI (US)

(72) Inventor: Ryan Torgerson, Burlington, WI (US)

(21) Appl. No.: 19/298,634

(22) Filed: Aug. 13, 2025

Related U.S. Application Data
(60) Provisional application No. 63/682,636, filed on Aug. 13, 2024.

(51) Int. Cl. G01W 1/04; G01P 5/07; G01W 1/14; H02S 20/20

(52) U.S. Cl. CPC G01W 1/04; G01P 5/07; G01W 1/14; H02S 20/20

(57) ABSTRACT

A weather measurement instrument sensor includes a housing having a top surface, a bottom surface, and a sidewall that at least partially define an interior volume within the housing, a first arm coupled to the housing and rotatable relative to the housing between a stowed position and a use position, a second arm spaced apart from the first arm, coupled to the housing, and rotatable relative to the housing between a stowed position and a use position, a first attachment coupled to a distal end of the first arm to facilitate measurement of a first environmental variable, and a second attachment coupled to a distal end of the second arm to facilitate measurement of a second environmental variable. The distal end of the first arm is nearer to the distal end of the second arm in the stowed position than in the use position.

### CROSS-REFERENCE TO RELATED APPLICATIONS

This application claims priority to U.S. Provisional Application No. 63/682,636, filed Aug. 13, 2024, the entire contents of which are incorporated herein by reference.

### BACKGROUND

Weather stations receive readings for indoor and outdoor temperature, humidity, wind speed and direction, barometric pressure trends, and rainfall totals. Some systems provide personalized weather forecasts and alerts.

### SUMMARY

In some aspects, the techniques described herein relate to a weather measurement instrument sensor including: a housing having a top surface, a bottom surface, and a sidewall that at least partially define an interior volume within the housing; a first arm coupled to the housing and rotatable relative to the housing between a stowed position and a use position; a second arm spaced apart from the first arm, coupled to the housing, and rotatable relative to the housing between a stowed position and a use position; a first attachment coupled to a distal end of the first arm to facilitate measurement of a first environmental variable; and a second attachment coupled to a distal end of the second arm to facilitate measurement of a second environmental variable; wherein the distal end of the first arm is nearer to the distal end of the second arm in the stowed position than in the use position.

In some aspects, the techniques described herein relate to a weather measurement instrument sensor, wherein the first arm is rotatable relative to the housing about a first axis, wherein the second arm is rotatable relative to the housing about a second axis, and wherein the first axis is parallel to the second axis.

In some aspects, the techniques described herein relate to a weather measurement instrument sensor, further including a controller positioned within the interior volume of the housing.

In some aspects, the techniques described herein relate to a weather measurement instrument sensor, further including a first sensor configured to measure an output of the first attachment and a second sensor configured to measure an output of the second attachment, wherein the controller is configured to receive a signal from the first sensor and a signal from the second sensor.

In some aspects, the techniques described herein relate to a weather measurement instrument sensor, wherein the first attachment is a wind direction vane, and the first sensor is configured to measure a wind direction, and wherein the second attachment is an anemometer, and the second sensor is configured to measure a wind speed.

In some aspects, the techniques described herein relate to a weather measurement instrument sensor, wherein the first attachment is a wind direction vane coupled to the distal end of the first arm to facilitate measurement of a wind direction, and the second attachment is an anemometer coupled to the distal end of the second arm to facilitate measurement of a wind speed.

In some aspects, the techniques described herein relate to a weather measurement instrument sensor, further including a water funnel coupled to the top surface of the housing, the water funnel configured to direct a collected rainfall to a rain tipping bucket positioned within the interior volume of the housing.

In some aspects, the techniques described herein relate to a weather measurement instrument sensor, further including a tiered strainer positioned within the water funnel, wherein the tiered strainer is configured to regulate a flow rate of the collected rainfall through the water funnel.

In some aspects, the techniques described herein relate to a weather measurement instrument sensor, wherein the rain tipping bucket includes an axis about which the rain tipping bucket is rotatable, a magnet coupled to the rain tipping bucket, and a reed type switch configured to measure a tipping event of the rain tipping bucket about the axis.

In some aspects, the techniques described herein relate to a weather measurement instrument sensor, further including a gutter formed within the housing and configured to direct the collected rainfall from the rain tipping bucket out of the housing.

In some aspects, the techniques described herein relate to a weather measurement instrument sensor, further including a fence positioned relative to the gutter to permit outflow of the collected rainfall and discourage insects from entering the housing at the gutter.

In some aspects, the techniques described herein relate to a weather measurement instrument sensor, wherein the housing includes an upper housing coupled to and separable from a lower housing, wherein the upper housing defines the top surface, wherein the lower housing defines the bottom surface, and wherein the sidewall includes a sidewall of the upper housing extending downward from the top surface and a sidewall of the lower housing extending upward from the bottom surface.

In some aspects, the techniques described herein relate to a weather measurement instrument sensor, wherein the sidewall of the upper housing and the sidewall of the lower housing are nested to overlap one another.

In some aspects, the techniques described herein relate to a weather measurement instrument sensor, further including a temperature and humidity chamber including a temperature sensor, a humidity sensor, and a fan configured to generate an airflow across the temperature sensor and the humidity sensor.

In some aspects, the techniques described herein relate to a weather measurement instrument sensor, wherein the temperature and humidity chamber is formed by a louvered arrangement extending from the bottom surface of the housing such that the temperature and humidity chamber is formed outside of the housing.

In some aspects, the techniques described herein relate to a weather measurement instrument sensor, wherein the fan is a vertically-mounted centrifugal fan.

In some aspects, the techniques described herein relate to a weather measurement instrument sensor, wherein the fan is driven by a motor, and wherein the motor is powered by a solar cell coupled to the housing.

In some aspects, the techniques described herein relate to a weather measurement instrument sensor, further including an insect repellant chamber formed within the housing, wherein the insect repellent chamber is configured to hold an insect repellant therein.

In some aspects, the techniques described herein relate to a weather measurement instrument sensor, further including a solar cell coupled to the housing, wherein the insect repellant chamber is located beneath the solar cell such that increased heat from solar radiation warms the insect repellent within the insect repellent chamber to circulate fumes generated by the insect repellant via convection.

In some aspects, the techniques described herein relate to a weather measurement instrument sensor including: a housing having a top surface, a bottom surface, and a sidewall that at least partially define an interior volume within the housing; a first arm coupled to the housing and rotatable relative to the housing between a stowed position and a use position; a second arm spaced apart from the first arm, coupled to the housing, and rotatable relative to the housing between a stowed position and a use position; a wind direction vane coupled to a distal end of the first arm to facilitate measurement of a wind direction; an anemometer coupled to a distal end of the second arm to facilitate measurement of a wind speed; a temperature and humidity chamber including a temperature sensor, a humidity sensor, and a fan configured to generate an airflow across the temperature sensor and the humidity sensor; a water funnel coupled to the top surface of the housing, the water funnel configured to direct a collected rainfall to a rain tipping bucket positioned within the interior volume of the housing; an insect repellant chamber formed within the housing, wherein the insect repellant chamber is configured to hold an insect repellant therein; and wherein the first arm is rotatable relative to the housing about a first axis, wherein the second arm is rotatable relative to the housing about a second axis, and wherein the first axis is parallel to the second axis, and wherein the housing includes an upper housing coupled to and separable from a lower housing, wherein the upper housing defines the top surface, wherein the lower housing defines the bottom surface, and wherein the sidewall includes a sidewall of the upper housing extending downward from the top surface and a sidewall of the lower housing extending upward from the bottom surface, wherein the sidewall of the upper housing and the sidewall of the lower housing are nested to overlap one another.

### BRIEF DESCRIPTION OF THE DRAWINGS

FIG. 1 is an upper perspective view of a weather measurement instrument sensor.

FIG. 2 is a lower perspective view of the weather measurement instrument sensor of FIG. 1.

FIG. 3 is a top view of the weather measurement instrument sensor of FIG. 1.

FIG. 4 is a bottom view of the weather measurement instrument sensor of FIG. 1.

FIG. 5 is a front view of the weather measurement instrument sensor of FIG. 1.

FIG. 6 is a rear view of the weather measurement instrument sensor of FIG. 1.

FIG. 7 is a first side view of the weather measurement instrument sensor of FIG. 1.

FIG. 8 is a second side view of the weather measurement instrument sensor of FIG. 1.

FIG. 9A is a first exploded perspective view of the weather measurement instrument sensor of FIG. 1.

FIG. 9B is a second exploded perspective view of the weather measurement instrument sensor of FIG. 1.

FIG. 10A is a top view of the weather measurement instrument sensor of FIG. 1 in a stowed position.

FIG. 10B is a top view of the weather measurement instrument sensor of FIG. 1 in an intermediate assembly step in which sensor arms are folded outward.

FIG. 10C is a top view of the weather measurement instrument sensor of FIG. 1 in an assembled position in which a wind vane is coupled to a first sensor arm and an anemometer is coupled to a second sensor arm.

FIG. 10D is a side view of the weather measurement instrument sensor of FIG. 1 in the stowed position.

FIG. 10E is a side view of the weather measurement instrument sensor of FIG. 1 in the assembled position and mounted on a mounting surface of the environment.

FIG. 11A is a perspective view of the weather measurement instrument sensor of FIG. 1 with the arms in a folded position.

FIG. 11B is a perspective view of the weather measurement instrument sensor of FIG. 1 with the arms in an unfolded position.

FIG. 12 is a perspective view of the weather measurement instrument sensor of FIG. 1 with an upper housing portion removed to illustrate the interior of the weather measurement instrument sensor.

FIG. 13 is a perspective view of the sensor arms of the weather measurement instrument sensor of FIG. 1.

FIG. 14 is a cross-sectional view of the weather measurement instrument sensor of FIG. 1 illustrating a solar panel and an insect repellant.

FIG. 15 is a cross-sectional view of the weather measurement instrument sensor of FIG. 1 illustrating a double thickness hull.

FIG. 16 is a cross-sectional view of a water funnel of the weather measurement instrument sensor of FIG. 1.

FIG. 17 illustrates a display for providing measured and recorded data to a user from the weather measurement instrument sensor of FIG. 1.

FIG. 18 is a schematic diagram of a controller of the weather measurement instrument sensor of FIG. 1 with various inputs and outputs.

FIG. 19 is a schematic representation of the weather measurement instrument sensor of FIG. 1 with various electronic components illustrated.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

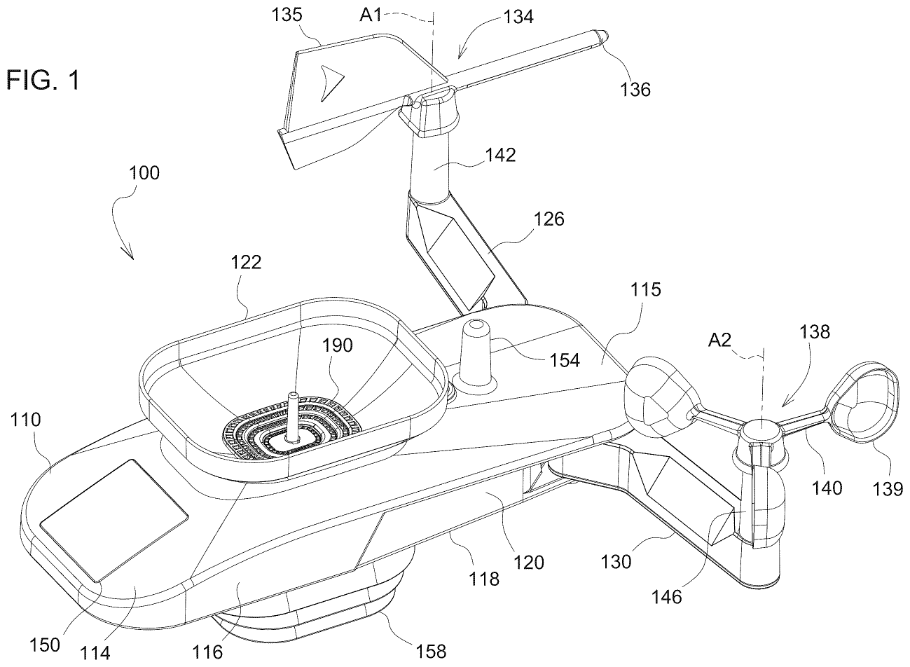

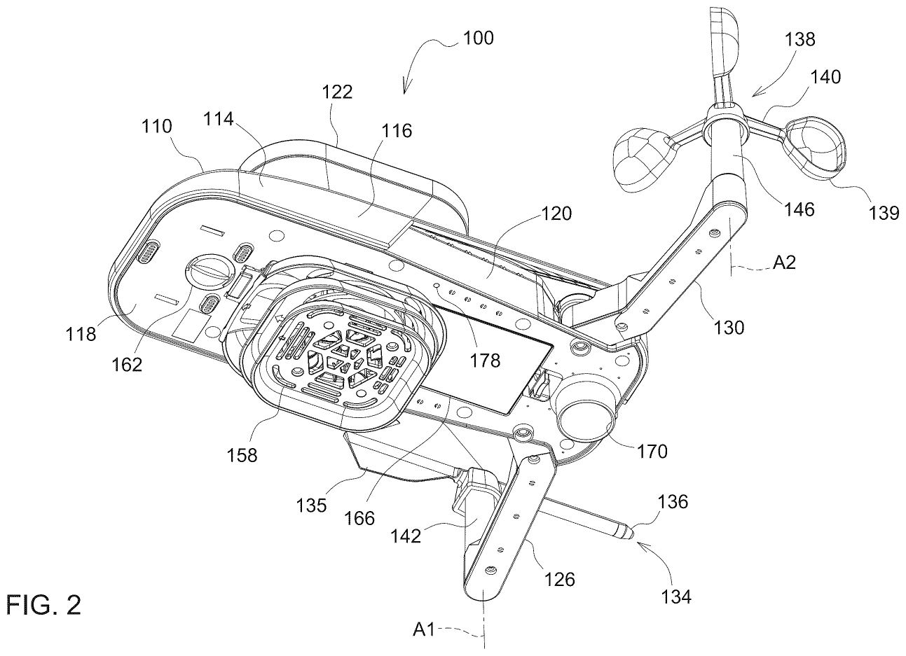

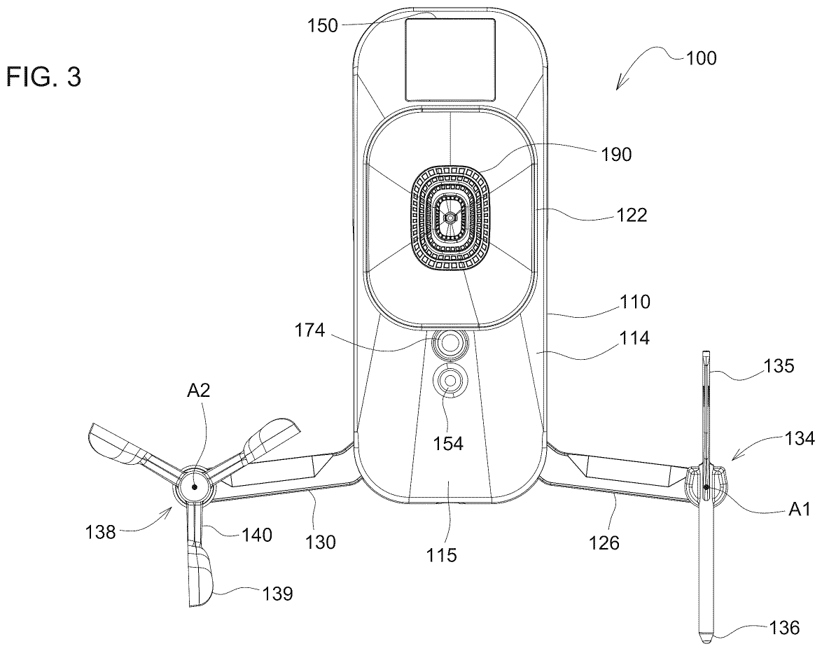

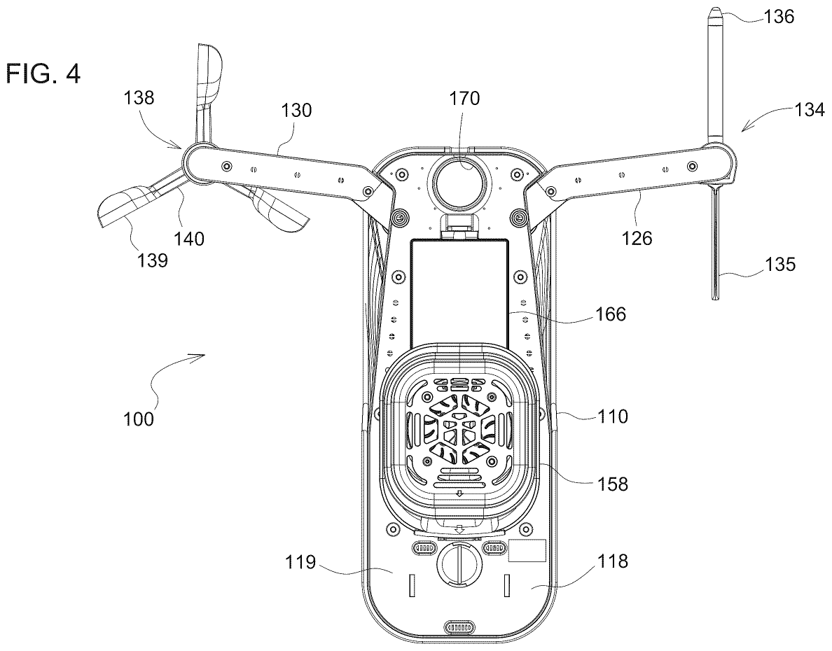

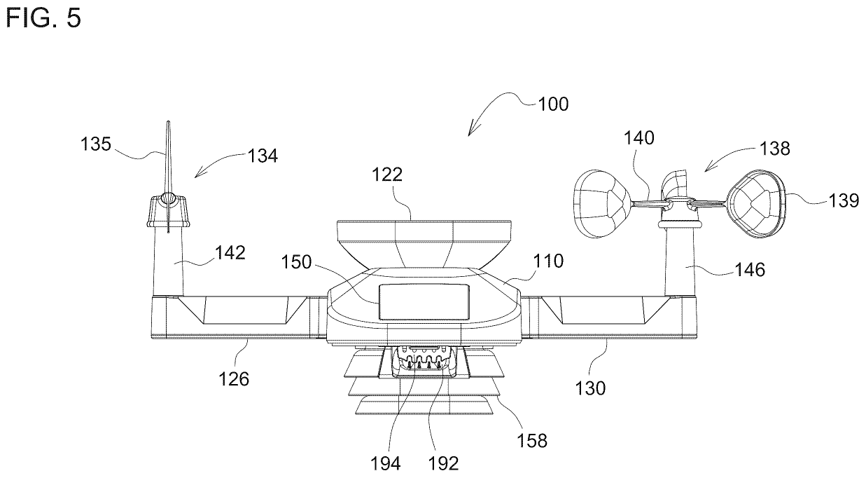

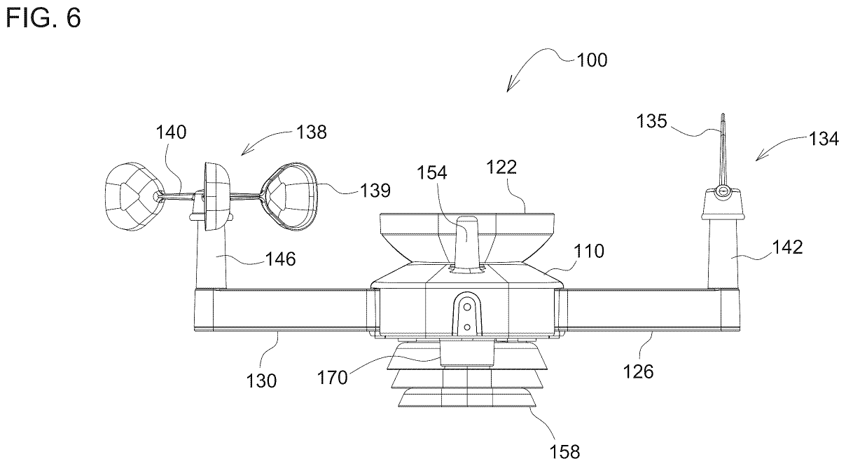

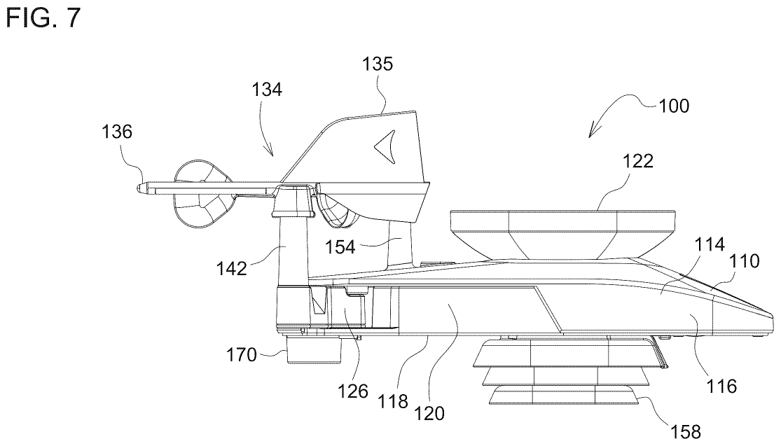

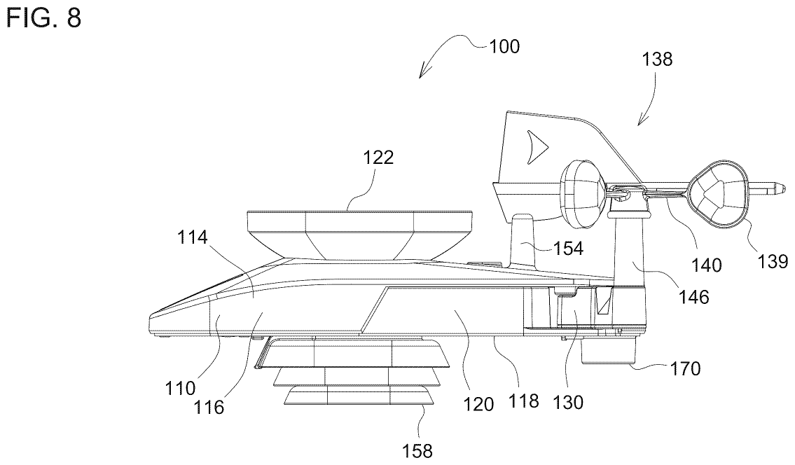

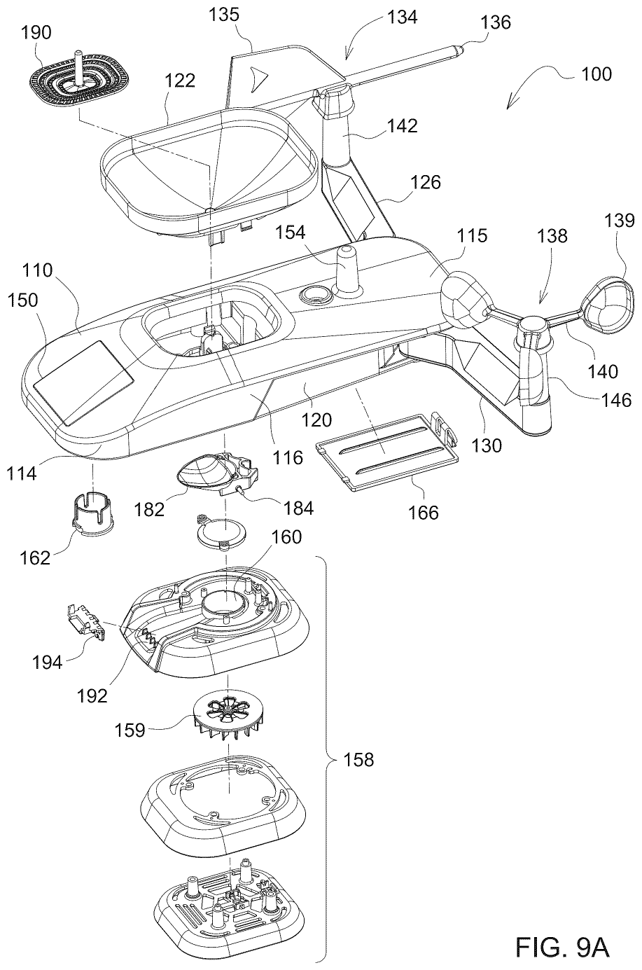

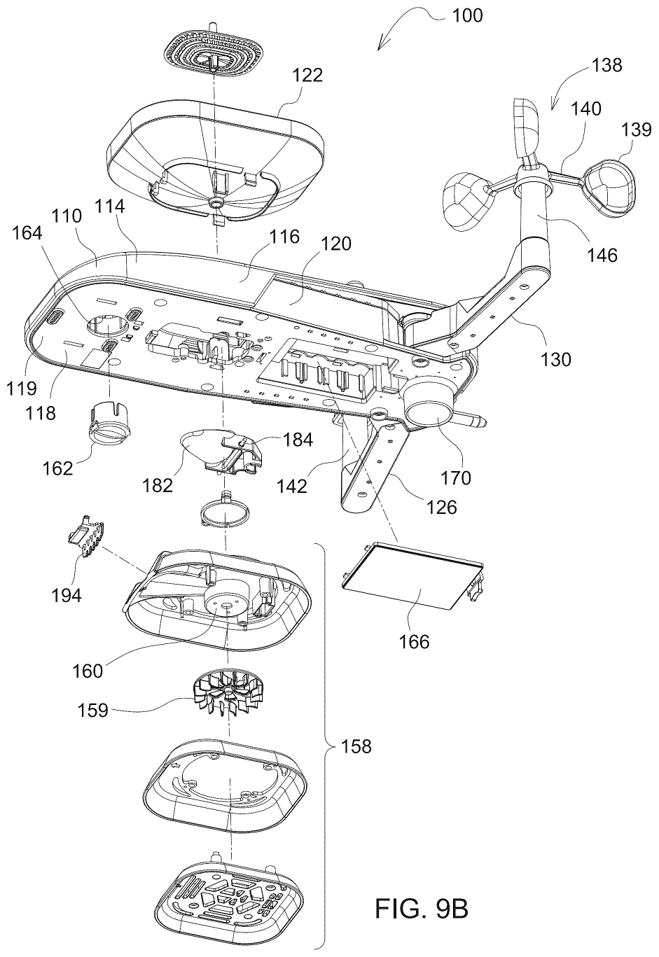

A weather measurement instrument sensor 100, also referred to herein as a weather sensor system, is illustrated via various views in FIGS. 1-8 and is further shown with exploded views in FIGS. 9A and 9B. The figures illustrate the multipurpose weather measurement instrument sensor system 100 in which a fan 159 circulates air past a temperature sensor 332 and other sensors (e.g., a humidity sensor 328). Further, a basin or water funnel 122 collects rainwater and precisely directs the rainwater into a tipping receptacle 182 to measure the amount of rainwater collected per unit time. Further still, a wind speed gauge 138 and wind direction vane 134 are foldable between stowed and deployed positions to decrease the overall size of the sensor system 100 when not in use to provide compact shipping and improved shelf space. Fold-out sensor arms 126, 130 allow for compact shipping and more separation between weather sensing components when deployed.

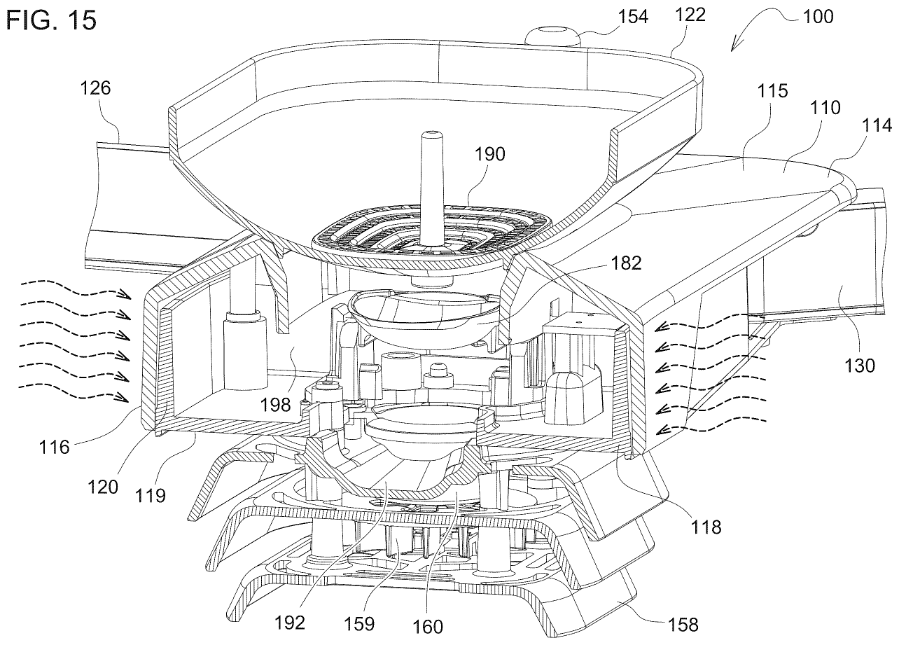

The weather measurement instrument sensor 100 includes a housing 110 having an upper housing 114 and a lower housing 118 that collectively define an interior volume of a main body of the device 100. The upper housing 114 includes a top surface 115 that, when mounted in the illustrated orientation, is above the lower housing 118. The upper housing 114 also includes a sidewall 116 extending downward along at least some of the edges of the housing 110 from the top surface 115. The lower housing 118 includes a bottom surface 119 that, when assembled, is substantially opposite the top surface 115, and a sidewall 120 that extends upwards from the bottom surface 119 towards the top surface 115 of the upper housing 114. In the illustrated embodiment, the sidewalls 116, 120 overlap one another, as described in greater detail with respect to FIG. 15. In some embodiments, the housing 110 is formed of a tinted black polycarbonate for reduced visual footprint in a backyard environment.

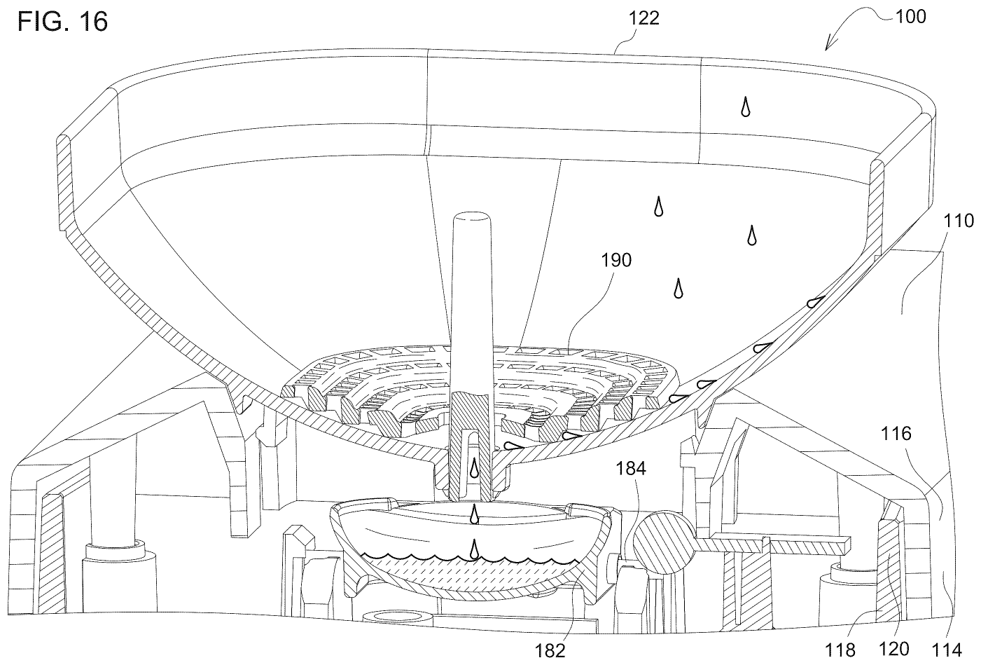

A water funnel 122 is coupled to the housing 110 and, in particular, is mounted to the top surface 115 of the upper housing 114. The water funnel 122 is a bucket or bowl having sidewalls that extend upward from a base to an upper rim. The water funnel 122 is configured to collect rainwater and direct the rainwater through an opening within the base of the funnel 122 and to a rain tipping bucket 182, which is described in greater detail with respect to FIGS. 15-16. A strainer 190 is positioned within the water funnel 122 to limit the speed of the water passing through the water funnel 122 and to also prevent debris (e.g., leaves) from blocking the opening at the base of the funnel 122.

As shown in greater detail in FIGS. 9A and 9B, a rain tipping bucket 182 is positioned below the water funnel 122 to collect the water from the water funnel 122. In the illustrated embodiment, the rain tipping bucket 182 is positioned within the housing 110. The rain tipping bucket 182 is mounted on an axle 184 for rotation about the axle 184 upon a known weight of rainwater within the bucket 182. Each tipping and emptying of the bucket 182 is counted and summed to determine a total rainfall. The water dumped from the bucket 182 exits the housing 110 via a gutter 192 that functions as a spout, directing the water to the environment (e.g., ground around the weather sensor system 100). A fence 194 is positioned within the gutter 192 to discourage insects from entering the housing 110 at the gutter 192.

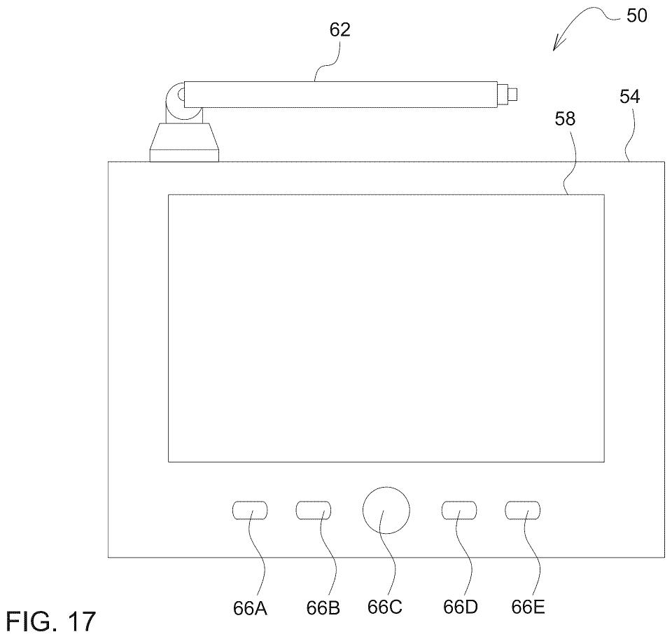

In some embodiments, as shown in greater detail in FIG. 16, the strainer 190 of the water funnel 122 includes multiple (e.g., four) concentric tiers. The integrated removable rain strainer 190 contains features to strain foreign debris out of incoming rain through apertures therein. The strainer 190 also features “tiers” or “steps” which serve to regulate (i.e., meter or slow down) the incoming rain and better control rain water entry into the metered area below which measures and records the rain accumulation electronically and sends the total to the display 50 (FIG. 17) via RF communication. The tiers each individually serve as small dams, causing the rain to accumulate on the outer, upper most “step” first, and then slowly drain through the strainer holes into the shielded funnel collection point below. Should the upper most step be overwhelmed with accumulated rainwater, the rainwater will then spill over into the next step below, continuing on until the innermost/lowest step (tier 4). The tiered water strainer aides in preventing the water measuring component 182 from being overwhelmed by too high of a flow of incoming rain water, allowing the measuring component 182 to more accurately measure incoming rain water.

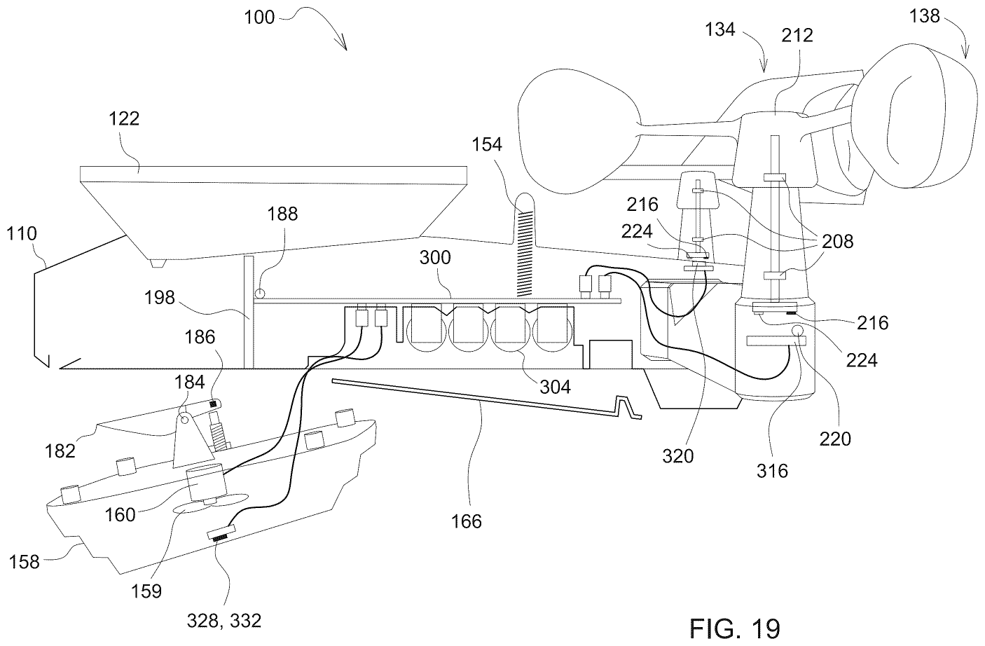

In some embodiments, the funnel 122 is a a translucent rain collection funnel positioned atop the housing 110 to collect rainfall and direct the flow of rainwater through the captured multi-tiered strainer 190. The translucent nature of the collection funnel 122 allows sunlight energy to partially enter the rainfall counting area, which will help to thaw any ice that may accumulate during the natural course of changing weather conditions. The captured rain strainer 190 can be removed in the field without tools such that foreign debris can be cleared out of the collection funnel 122, thereby serving to prevent foreign debris from entering the rainfall counting area below. The strainer 190 utilizes different tier levels, or steps, of the strainer itself to control and slow down the accumulated flow of rain. This configuration allows the counting device below to more accurately count the rainfall amount by decreasing the flow rate enough to allow the mechanical rain counting device 182 to recover before being filled again. The rain tipping bucket 182 is the counting device and is uniquely shaped with a scoop-shape. The surface of the tipping bucket 182 is also subjected to special finishing techniques to make the surface more hydrophobic as to encourage more complete emptying of accumulated raindrops. The tipping bucket 182 is balanced carefully on an axle 184 that allows the weight of the accumulated raindrops to shift the center of gravity away from the axle 184, such that the tipping bucket 182 will empty itself of the known rainfall amount quickly and completely. As shown in FIG. 19, a captured magnet 186 is mounted on an end of the scoop (opposite the tipping direction). Through the action of emptying itself, the scoop magnet 186 swings past a reed type switch 188 to register the calibrated amount with the integrated internal electronic components.

The now empty tipping bucket 182 then tilts back up to its normal state due to the center of gravity shifting back towards the axle 184 due to the magnet 186 functioning as a counterweight on the opposite side of the axle 184. The now discarded accumulated raindrops exit through the gutter 192 that features a uniquely shaped interlocking fence type component 196 that permits outflow (i.e., allows water out) but discourages flying insects from entering. The fence component 196 is also configured in such a way that allows post metered rain water to drain in freezing conditions where layers of rain water may freeze and otherwise block additional water from draining.

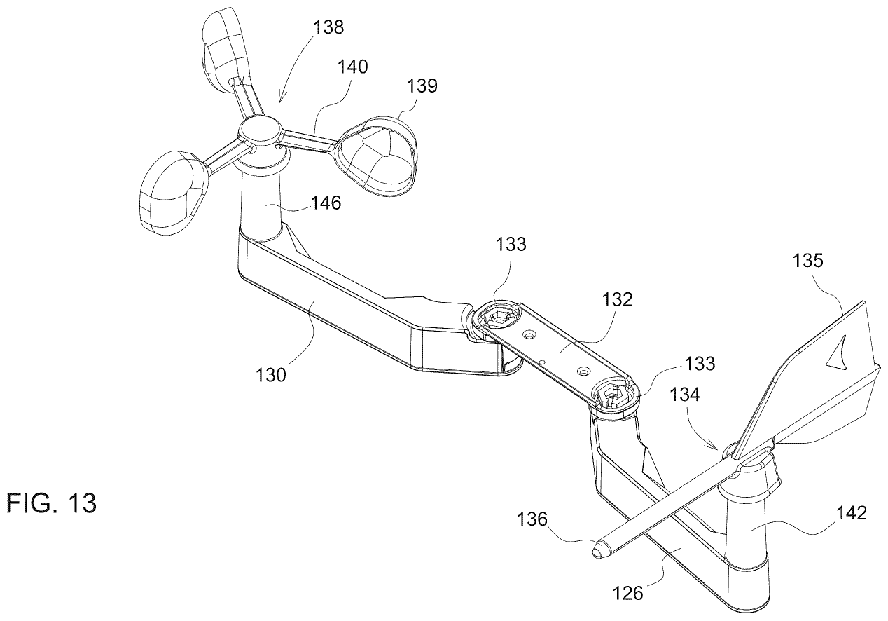

A first sensor arm 126 and a second sensor arm 130 are coupled to and extend outward from opposite sides of the housing 110. As shown, the sidewalls 116, 120 of the housing 110 include openings through which the first and second sensor arms 126, 130 extend outward from an interior of the housing 110. As described in greater detail below with respect to FIG. 13, the arms 126, 130 are connected to one another via a flex plate 132 located within the interior of the housing 110. In a deployed position, as shown in FIGS. 1-8, the sensor arms 126, 130 extend outward and away from the housing 110 to support measurement attachments for facilitating the measurement of environmental variables (e.g., rainfall, temperature, humidity, wind speed, wind direction, air pressure, solar radiation, cloud cover, visibility, Ozone concentration, air quality index, etc.) at locations that are spaced apart from the housing 110 and from one another. In the illustrated mounting configuration, the arms 126, 130 extend substantially horizontally in plane with the major axes of the housing 110.

In the illustrated embodiment, the first sensor arm 126 supports a wind direction measurement attachment 134 (i.e., wind direction vane). The wind direction measurement attachment 134 is shaped substantially like an arrow, having a fin 135 at one end and a pointer at a second end. The wind direction measurement attachment 134 is mounted to a distal end of the first arm 126 by a shaft 142 (e.g., a vertically-extending shaft). The shaft 142 defines a rotational axis A1 about which the attachment 134 is rotatable to indicate a direction of the wind. Further, in the illustrated embodiment, the second sensor arm 130 supports a wind speed measurement attachment 138 (i.e., anemometer). The wind speed measurement attachment 138 includes cup-shaped wind catchers 139 mounted on horizontal arms 140 extending outward from a shaft 146 (e.g., a vertically-extending shaft). The shaft 146 couples the attachment 138 to the second arm 130 and defines a rotational axis A2 about which the attachment 138 is rotatable to measure a speed of the wind. In some embodiments, the shafts 142, 146 are coupled to the arms 126, 130, and in other embodiments, the shafts 142, 146 are coupled to the attachments 134, 138. In the illustrated embodiment, the rotational axes A1, A2 are parallel to one another. In some embodiments, the attachments 134, 138 are switchable with one another and/or with replacement attachments, including attachments that differ from the illustrated wind direction and wind speed measurement attachments 134, 138.

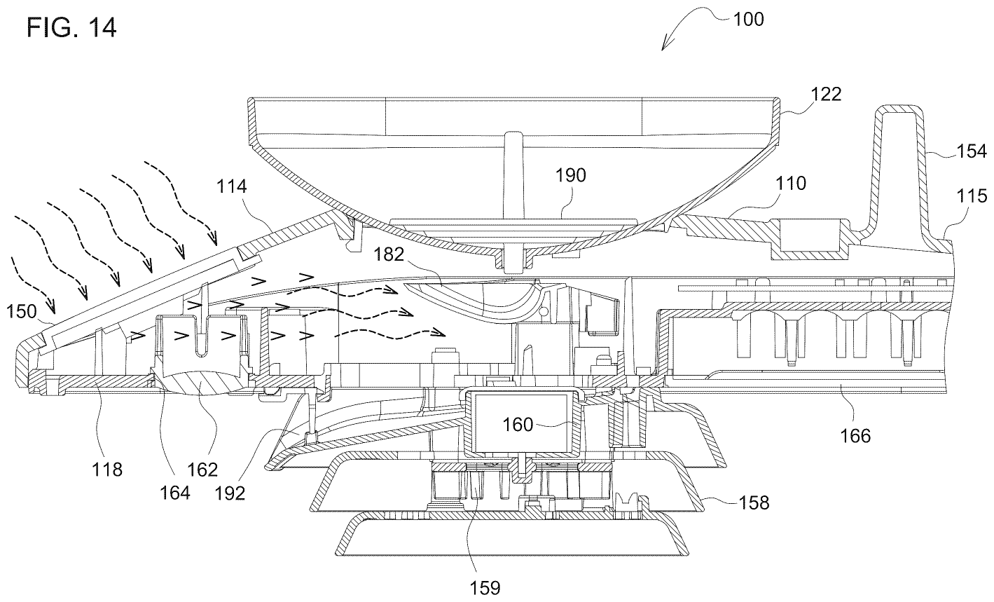

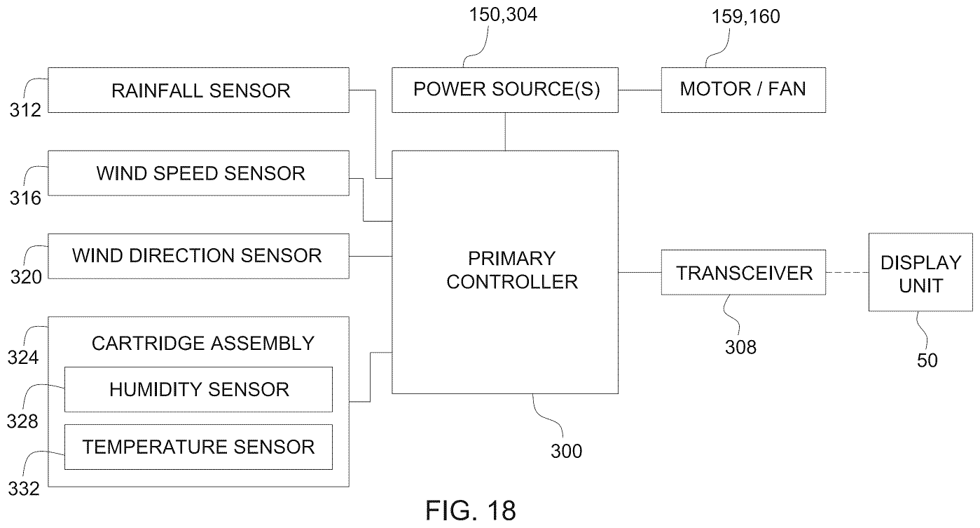

A solar cell 150 is coupled to the housing 110 and, in the illustrated embodiment, is coupled to the top surface 115 of the upper housing 114 to face and receive sunlight. The solar cell 150, in some embodiments, functions in concert with an insect repellant chamber 162 to discourage insects from inhabiting the weather measurement instrument sensor 100, as described in greater detail below with respect to FIG. 14. The insect repellant chamber 162 is a housing configured to hold an insect repellant such as a moth ball therein. The chamber 162 is positioned within an opening 164 formed on the bottom surface 119 of the lower housing 118. In some embodiments, the solar cell 150 may provide power to one or more of the electronic components illustrated and described with respect to FIGS. 18-19.

Some prior art weather sensors are affected by insects inhabiting the weather sensor system, which can interfere with operation of various sensors within the weather sensor system. As shown in FIG. 14, the weather sensor 100 includes a compartment 162 in which insect repellant (e.g., a moth ball) can be installed. The location of the insect repellant is situated beneath the solar panel 150 so that the increased heat from solar radiation warms the repellant and helps to circulate the fumes throughout the weather sensor 100 by the process of convection. By continuously flooding the weather sensor compartment 162 with the insect repellent fumes the weather sensor becomes a much less attractive home for the various insects that would typically inhabit a weather sensor system. The insect repellent chamber 162 is an easily accessible, removable, and maintainable holding device to hold and disperse an insect repellant material that is continually aided in dispersing throughout the internal cavity via passive solar convection via the adjacent solar panel 150 that, in some embodiments, is also used for powering the motor 160 that drives the internal aspiration fan 159. The user may remove the insect repellant holder 162 and load with an insect repellant. The user may then replace the insect repellant holder 162 into the opening 164. As the sun heats the solar panel 150 located just above the insect repellant holder 162, the convective air movement aids in dispersing the insect repellant within the sensor cavity within the housing 110. The user may choose to reload the insect repellant holder on a regular schedule to aid in keeping insects out and keep the product functioning as designed in an outdoor environment.

In some embodiments, the insect repellant chamber 162 is a small removable, integrated circular compartment formed into the bottom front of the device 100. The compartment is intended to be accessed in the field by the user, where they may choose to annually place commercially available insect repellants, (e.g., moth balls). Alternatively, the user may choose to place a cotton ball or similar carrier soaked with a compatible homemade insect deterrent. The compartment 162 is removable by twisting the handle and pulling down. The compartment 162 is located directly below the solar cell area, which is typically heated by the sun throughout the day. This heating affect creates natural convection which helps to distribute the off-gassing fumes from the chosen anti-insect agent into the rain gauge area below the funnel 122, and above the temperature and humidity louvered area 158. This arrangement actively aids in discouraging flying and crawling insect intrusion and/or nesting in these susceptible areas which must remain somewhat open by design for airflow and water flow to allow for accurate environmental condition measurement.

A temperature and humidity chamber 158 is formed on the underside of the housing 110, outside of the housing 110, and is coupled to and positioned below the bottom surface 119 of the lower housing 118. The temperature and humidity chamber 158 is formed as a louvered arrangement of three tiers, having various inlets therethrough. A fan 159 and a motor 160 are positioned within the chamber 158 to generate an airflow relative to humidity and temperature sensors 328, 332, which are described in greater detail with respect to FIGS. 18 and 19.

The solar cell 150 located near the front of the housing 110 is utilized for powering the internal aspirating fan 159 (driven by the motor 160), which is positioned within the multi-louvre temperature and humidity chamber 158 on the bottom of the device 100. The fan 159 is selected to provide sufficient air moving force, whilst simultaneously being light enough to not require excessive startup torque from the solar powered DC electric motor 160. The multi louvres of the temperature and humidity chamber 158 serve to deflect direct solar heating while also being configured in a manner that is open enough to encourage positive airflow, which is beneficial for accurate temperature and humidity measurement. Active airflow is directed past and around the temperature and humidity sensing area, created by the aspirating fan 159 whenever the sun is significantly available to affect power creation by the solar cell 150. This active airflow cools the area around the sensors 328, 332 when the sun is shining. Without the aspirating fan 159, the sun may heat the louvre temperature and humidity sensing area 158 to the point that it would report artificially high temperatures and inaccurate associated humidity. The temperature and humidity electronic sensing components 328, 332 are integrated onto a small, circuit board cartridge 324 (FIG. 18) that sends data via a connector with the integrated internal electronic components 300. The cartridge assembly 324 is configured in a way that allows for field removal and replacement should it wear in outdoor conditions to become non-functioning, or to maintain accuracy. A user is able to access, assess the condition, and, if desired, replace the temperature and humidity cartridge 324 in the field utilizing simple common hand tools without disassembling or disturbing the housing 110 of the device 100.

The vertically-mounted centrifugal fan 159 provides a balance of low start up torque and optimum air moving efficiency. In contrast, similar weather products in the market that have aspirating fans utilize a more common axial-type fan, with a perpendicular air flow that is typically configured to blow air at the sensor. The centrifugal fan 159, paired with the stacked ventilated louvres of the temperature and humidity chamber 158 result in significantly improved temperature readings in testing.

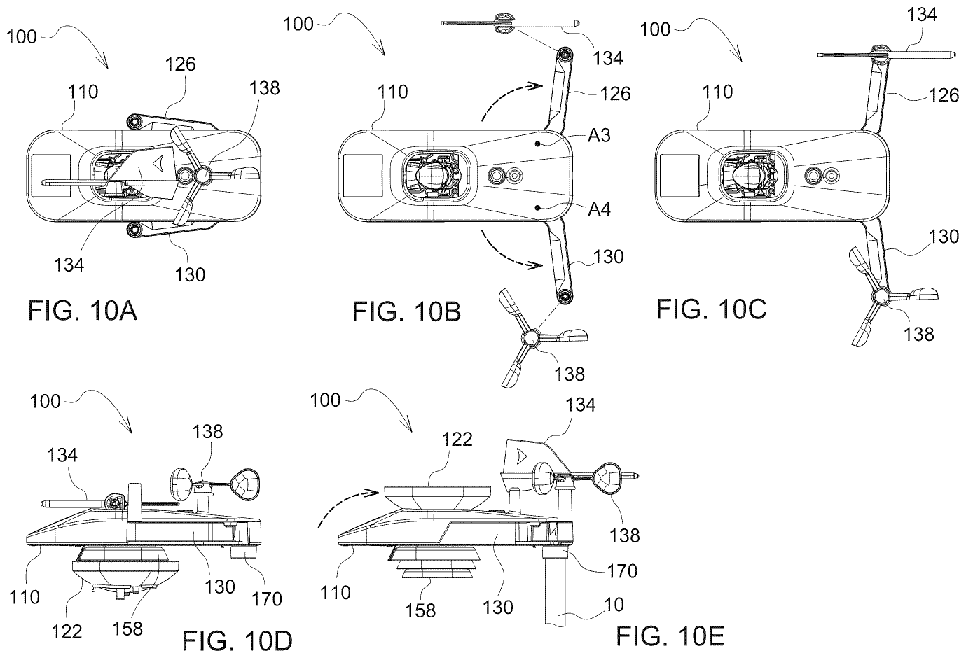

An access panel 166 is formed on the bottom surface 119 of the lower housing 118 and is openable to provide access to an interior of the housing 110. In the illustrated embodiment, the access panel 166 provides access to the power source (as shown, a plurality of batteries 304). In some embodiments, the access panel provides access to controllers and sensors positioned within the housing 110. A mounting cylinder 170 is coupled to the bottom surface 119 of the lower housing 118 and is formed as a hollow cylinder extending vertically downward from the bottom surface 119. A support post 10 (FIG. 10E) may be mounted within or around the mounting cylinder 170 to support the weather measurement instrument sensor 100 relative to a ground surface. An LED indicator 178 is positioned on the housing 110 and is viewable by a user when the weather measurement instrument sensor 100 is assembled. In some embodiments, the LED indicator 178 flashes every time the device transmits a RF data signal. In some embodiments, the LED indicator 178 serves to indicate standard operation to the end user, and to aid in diagnosing any potential problems with the system.

In some embodiments, an antenna 154 and a bubble level 174 are mounted to the housing 110. In the illustrated embodiment, the antenna 154 and bubble level 174 are mounted to the top surface 115 of the upper housing 114. The antenna 154 transmits wireless signals from the various measurement devices of the weather measurement instrument sensor 100 to a user (e.g., a display 50 viewable by a user, as shown in FIG. 17). The bubble level 174 indicates whether the weather measurement instrument sensor 100 is mounted in a level orientation, which can assist in accurate measurements of the outputs (e.g. rainfall, wind speed, and wind direction).

In some embodiments, the anemometer 138 is molded in black for better long term plastic durability and includes straight connecting arms for improved high-speed stability. The arms 126, 130 of the wind vane 134 and anemometer 138 are each movable between the stowed and deployed positions. In some embodiments, the two arms 126, 130 are movable together such that movement of one results in movement of the other. In another embodiment, the arms 126, 130 are separately movable.

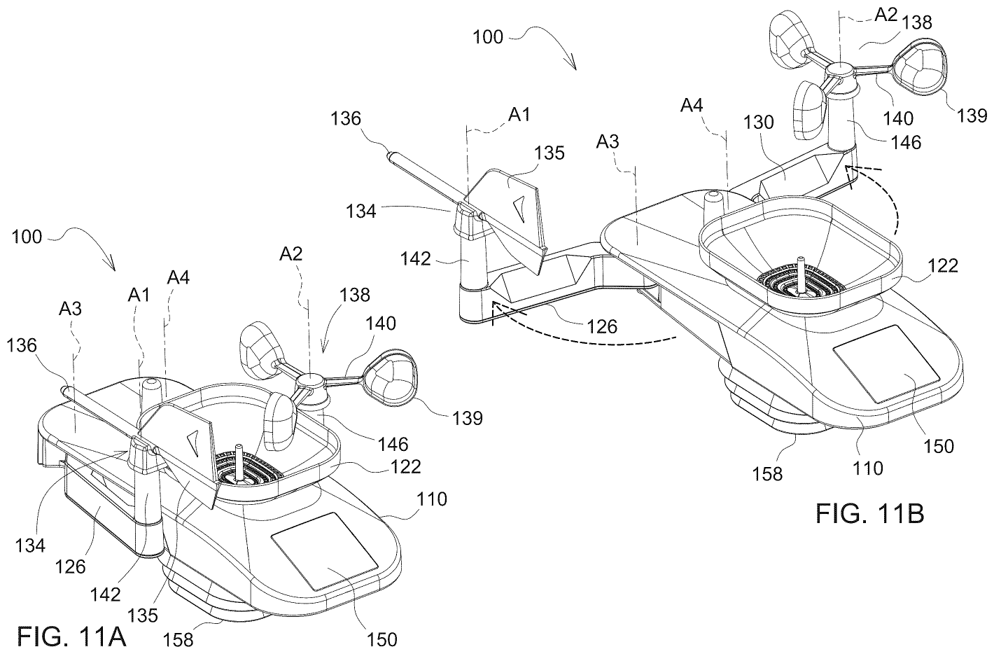

As shown in FIGS. 10A-11B, the weather sensor system 100 is movable between a stowed position (FIGS. 10A and 10D) and a use position (FIGS. 10C and 10E). In the stowed position, the weather sensor system 100 is compact and intended to fit within a smaller package for transit, relative to the use position. As illustrated, the arms 126, 130 are folded (at least partially) into the housing 110 and the water funnel 122 and the attachments 134, 138 are disassembled from the remainder of the system 100. FIG. 10B illustrates the arms 126, 130 folding out from the stowed position to the use position and the attachments 134, 138 removed from the stowed locations atop the housing 110 ready for assembly on the distal ends of the arms 126, 130, as shown in FIG. 10C. The distal ends of the arms 126, 130 are located adjacent (e.g., in contact with) the housing 110 in the stowed configuration and are spaced apart from the housing 110 in the use configuration. As such, the distal ends (upon which the shafts 142, 146 are positioned) are positioned nearer to one another in the stowed position than in the use position, providing additional space for the operation of the attachments 134, 138. FIGS. 11A and 11B further illustrates the stowed and use positions of the arms 126, 130, respectively. In some embodiments, the weather sensor system 100, in the stowed position, has a length of approximately 9.6″ and a height of approximately 5.3″. Prior art weather sensor systems can have dimensions of approximately 14″ in length and 11.5″ in height.

By deploying from a stowed position, the size of the sensor system 100, and therefore the size of the box within which the sensor system is shipped and displayed in retail locations is decreased. Large boxes provide a problem of shelf space for retailers who sell weather sensor systems and also increase the costs associated with shipping. The folding arms and low-profile body create a significantly reduced footprint compared to existing weather stations.

Folded in sensor arms 126, 130 provide a small product footprint when the product is stored and provide an expanded sensor component spacing for better performance and accuracy when sensor arms 126, 130 are folded out or deployed. The separate sensor arms 126, 130 also provide an ability for the attachments 134, 138 to be replaced as part of general maintenance, or should one or both of the attachments 134, 138, or any sensor arm components become damaged, a user may change out one or both of the sensor arms 126, 130 to keep the product in service. The separate sensor arms 126, 130 allow for future upgrades to the attachments 134, 138, sensing technologies, or sensing values/types to be upgraded and/or changed in the future, allowing for a more future proof product that can be improved and/or upgraded at the manufacturing facility or in the field by the end user. The device 100 is designed to be compact when in transit, stored, or when in an otherwise not in service configuration state. The device 100 is conversely designed to be transformed to locate sensing components to be accurate and robust when in its in-service installed configuration state. These two states are typically at odds with each other on similar purposed devices in the market.

The compact multi-sensor device 100 is fully self-contained and encases all of the sensor components that collectively provide an overview of environmental conditions. The compact device 100, in its stowed or packaged state, places the separate weather sensor components in such close proximity that accurate weather measurements are difficult to attain. The sensor arms 126, 130 containing the wind speed and wind direction sensor components, presented in their closed or stowed state, are each folded out to their fully extended and deployed position, where they have a definitive stop point in their rotation and be are fully open and deployed (FIG. 11B). As shown in FIG. 13, both wind arms 126, 130 are bound by an axle 133 with interlocking gears that interact with an internal flex plate bracket 132 to provide sufficient force and resistance as to keep the arms 126, 130 in the deployed state in normal conditions. In the case that external wind forces are significant, the deployed wind arms 126, 130 can be made to further resist stronger wind forces by tightening the integrated tension screws at each axle 133. When the wind sensor arms 126, 130 are fully deployed, the configuration and placement of the wind speed and direction sensor components 134, 138 and supporting structure are now significantly further away from the main housing 110 of the device 100. This transformed shape and configuration allows for increased accuracy in recording environmental measurements. The device 100 is mounted in a reasonably open space as to properly observe and report changing environmental conditions. Successful mounting of the device entails utilizing a mated installation adapting bracket 170, (e.g., utilizing common hand tools and appropriate fasteners) the device is securely mounted to an existing sturdy structure 10 (FIG. 10E) at the installation location. The device 100 is primarily powered by external power provided by batteries 304 (FIGS. 18, 19) (e.g., 4 AA type standard batteries), or alternatively by an associated optional power input accessories.

As shown in FIG. 15, in some embodiments, the housing 110 of the weather sensor system is a double thickness or “double hull” arrangement having outer sidewalls surround inner sidewalls. In the illustrated embodiment, the sidewalls 116 of the upper housing 114 are the outer sidewalls that surround the sidewalls 120 of the lower housing 118. A double material thickness wall aids in preventing excess thermal transfer from the sun at sunrise/sunset to the temperature/humidity sensor component 328, 332 (FIGS. 18-19) that is located within or directly below the housing 110. In the current embodiment, the sensors 328, 332 are mounted just below the rain gauge cavity within the temperature and humidity chamber 158. During most of the day, the sun is at a sufficiently high enough location and angle to power the internal aspirating fan 159 via the integrated solar panel 150. However, during early sunrise and late sunset, the suns position is lower on the horizon and may not provide enough power to the solar panel 150 to power the internal aspirating fan 159. At these times, the temperature sensor may be artificially heated above the actual ambient temperature via secondary heating from sunlight passing through the sidewalls of the sensor 100 and heating up the internal airspace. To prevent this heating effect when the sun is low on the horizon and the internal aspirating fan 159 cannot be run by the solar panel 150, the housing 110 of the weather sensor system 100 has a “double-hull” design which consists of an outer layer/top shell of ASA type plastic with an integrated UV inhibitor, and an inner layer/bottom shell of ABS type plastic with an integrated UV inhibitor.

The housing 110 is comprised of the upper and lower housings 114, 118. The upper housing material consists of an injection molded ASA plastic with a specialized color and resin formula to be UV and weather resistant for specific installation in outdoor environments. The upper housing 114 also includes integrated features to allow for optimal placement of the transmission antenna 154, the bubble level 174 for aiding user in level placement, strong mounting fastener location, a location for the solar cell 150 to be mounted, and an extended skirt or sidewall 116, which protrudes downward to wrap around the front and sides of the housing 110 of the device 100. The lower housing 118 consists of an injection molded ABS plastic component with a specialized color and resin formula to be reasonably weather resistant considering it is protected from most direct sunlight degradation by the upper housing 114. The lower housing 118 features a sidewall 120 that meets the backsides of the upper housing wall to provide a double wall arrangement to aid in limiting solar radiation from penetrating through to the lower louvred area where it would otherwise artificially raise the temperature readings.

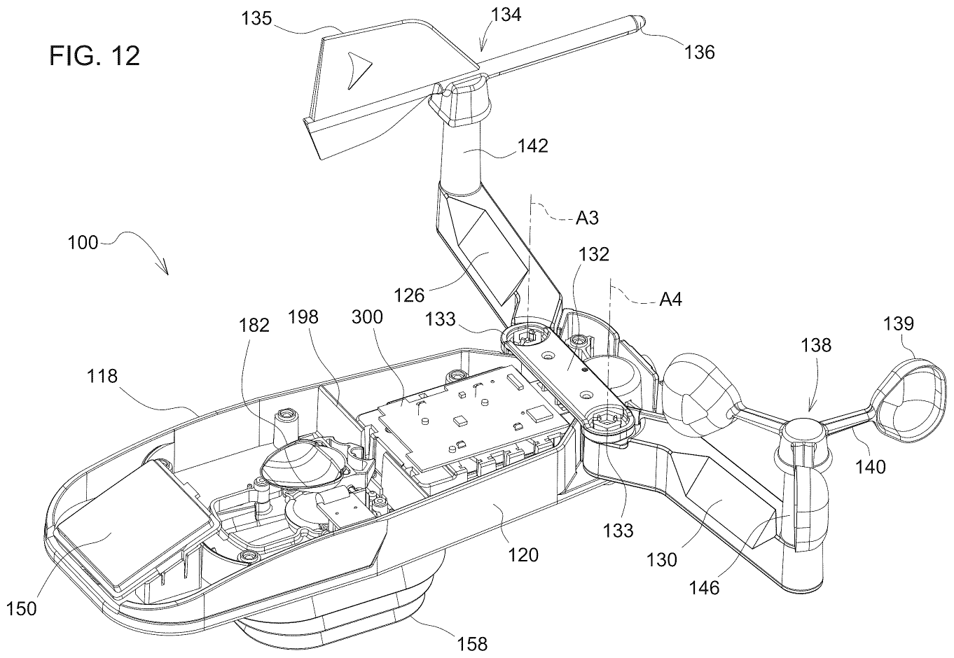

As shown in FIGS. 12 and 18, the lower housing 118 houses the integrated battery compartment (accessible via the access panel 166), significant structural ribs, a separating wall 198 between the electronic components 300 (rearward of the wall) and the wet rainfall measuring area (forward of the wall 198), attachment features for the two wind arms 126, 130 and associated structural components, all other externally mounted features, weep holes for draining any incidental water intrusion, and mating attachment points for the upper and lower housings 114, 118 to be combined with fasteners. All fasteners and metallic parts that are potentially exposed directly to the elements have corrosion resistant properties to aide in reliability and durability.

The wind speed measurement arm 130 includes upper and lower injection molded ASA plastic components with a specialized color and resin formula to be UV and weather resistant for specific installation in outdoor environments. Both components feature fastener locked mating surfaces to result in a strong, structural beam built to resist high winds commonly found in severe weather events. As shown in greater detail in FIGS. 13 and 19, the end of the wind speed arm 130 features a vertically positioned stainless steel shaft 146 with machined steps trapping it on a set of internal bearings 208 to permanently locate the shaft 146 appropriately for balanced and centered rotation at all speeds. The top of the shaft 146 features an injection molded pressed-on assembly of triple rotationally located wind capturing cups 139 connected by arms 140 and collectively referred to as the anemometer 138. These cups 139 and their connecting arms 140, as well as the center hub 212 are specially designed to be balanced and to capture wind from any direction without flexing or creating excess vibration. The bottom surfaces and edges of the hub 212 are tapered to shed water, ice and other foreign debris that may be accumulated. Concealed in the bottom of the wind arm 130, 146 below the vertical stainless-steel shaft 146 is an injection molded cap with an integrated center offset magnet 216 and counterweight 224 for balance. The RPMs of the magnet 216 are observed by an electronic component 316 which is then registered by the electronic components 300.

The wind direction arm 126 is similar in construction and finishing methods to the arm 130 for the anemometer 138 and only differs in two ways from the anemometer 138. The top of the vertically positioned stainless steel shaft 142 features a pressed-on wind vane 134 that is designed with a large vertical fin 135 designed to catch the wind direction and face the wind vane pointer 136 into the wind direction. The wind direction vane 134 is balanced to limit excessive wagging and settle into the prevailing wind direction with an integrated weight that is held in place in the wind vane tip 136. Concealed in the bottom of the wind arm 126, 142 below the vertical stainless-steel shaft 142 is an injection molded cap with an integrated magnet 216 that is aligned to the wind vane direction above. The position of the magnet 216 is observed by an electronic component 320 which can detect 1° out of a 360° potential and is then registered by the electronic components 300.

The most recent accumulated number of tipping events of the rain tipping bucket 182 (via rainfall sensor 312), current temperature (via temperature sensor 332), current humidity (via humidity sensor 328), current wind direction (via sensor 320), current wind speed (via sensor 316), and, in some embodiments, most recent lightning conditions are all electronically captured and, in some embodiments, recorded by the purpose built controller 300, as shown in FIG. 18. The controller 300 receives signals indicative of the recorded measurements from the various sensors and is powered by one or both of the power sources (solar cell 150, batteries 304), and preferably the batteries 304. The compiled data is transmitted via a transceiver (e.g., via radio frequency (RF)) to one or more receivers (e.g., display unit 50) that are specially designed to acquire the signal and the data from the transmitter and relay the information to the user. In the illustrated embodiment, the display 50 includes a housing 54 having a screen 58 for visually providing the collected data to the user, an antenna 62 for wirelessly receiving the data from the sensor system 100, and various inputs 66 for controlling the displayed information.

Although some aspects have been described in detail with reference to certain preferred embodiments, variations and modifications exist within the scope and spirit of one or more independent aspects as described.

What is claimed is:

1. A weather measurement instrument sensor comprising:
a housing having a top surface, a bottom surface, and a sidewall that at least partially define an interior volume within the housing;
a first arm coupled to the housing and rotatable relative to the housing between a stowed position and a use position;
a second arm spaced apart from the first arm, coupled to the housing, and rotatable relative to the housing between a stowed position and a use position;
a first attachment coupled to a distal end of the first arm to facilitate measurement of a first environmental variable; and
a second attachment coupled to a distal end of the second arm to facilitate measurement of a second environmental variable;
wherein the distal end of the first arm is nearer to the distal end of the second arm in the stowed position than in the use position.

2. The weather measurement instrument sensor of claim 1, wherein the first arm is rotatable relative to the housing about a first axis, wherein the second arm is rotatable relative to the housing about a second axis, and wherein the first axis is parallel to the second axis.

3. The weather measurement instrument sensor of claim 1, further comprising a controller positioned within the interior volume of the housing.

4. The weather measurement instrument sensor of claim 3, further comprising a first sensor configured to measure an output of the first attachment and a second sensor configured to measure an output of the second attachment, wherein the controller is configured to receive a signal from the first sensor and a signal from the second sensor.

5. The weather measurement instrument sensor of claim 4, wherein the first attachment is a wind direction vane, and the first sensor is configured to measure a wind direction, and wherein the second attachment is an anemometer, and the second sensor is configured to measure a wind speed.

6. The weather measurement instrument sensor of claim 1, wherein the first attachment is a wind direction vane coupled to the distal end of the first arm to facilitate measurement of a wind direction, and the second attachment is an anemometer coupled to the distal end of the second arm to facilitate measurement of a wind speed.

7. The weather measurement instrument sensor of claim 1, further comprising a water funnel coupled to the top surface of the housing, the water funnel configured to direct a collected rainfall to a rain tipping bucket positioned within the interior volume of the housing.

8. The weather measurement instrument sensor of claim 7, further comprising a tiered strainer positioned within the water funnel, wherein the tiered strainer is configured to regulate a flow rate of the collected rainfall through the water funnel.

9. The weather measurement instrument sensor of claim 7, wherein the rain tipping bucket includes an axis about which the rain tipping bucket is rotatable, a magnet coupled to the rain tipping bucket, and a reed type switch configured to measure a tipping event of the rain tipping bucket about the axis.

10. The weather measurement instrument sensor of claim 7, further comprising a gutter formed within the housing and configured to direct the collected rainfall from the rain tipping bucket out of the housing.

11. The weather measurement instrument sensor of claim 10, further comprising a fence positioned relative to the gutter to permit outflow of the collected rainfall and discourage insects from entering the housing at the gutter.

12. The weather measurement instrument sensor of claim 1, wherein the housing includes an upper housing coupled to and separable from a lower housing, wherein the upper housing defines the top surface, wherein the lower housing defines the bottom surface, and wherein the sidewall includes a sidewall of the upper housing extending downward from the top surface and a sidewall of the lower housing extending upward from the bottom surface.

13. The weather measurement instrument sensor of claim 12, wherein the sidewall of the upper housing and the sidewall of the lower housing are nested to overlap one another.

14. The weather measurement instrument sensor of claim 1, further comprising a temperature and humidity chamber including a temperature sensor, a humidity sensor, and a fan configured to generate an airflow across the temperature sensor and the humidity sensor.

15. The weather measurement instrument sensor of claim 14, wherein the temperature and humidity chamber is formed by a louvered arrangement extending from the bottom surface of the housing such that the temperature and humidity chamber is formed outside of the housing.

16. The weather measurement instrument sensor of claim 14, wherein the fan is a vertically-mounted centrifugal fan.

17. The weather measurement instrument sensor of claim 14, wherein the fan is driven by a motor, and wherein the motor is powered by a solar cell coupled to the housing.

18. The weather measurement instrument sensor of claim 1, further comprising an insect repellant chamber formed within the housing, wherein the insect repellant chamber is configured to hold an insect repellent therein.

19. The weather measurement instrument sensor of claim 18, further comprising a solar cell coupled to the housing, wherein the insect repellant chamber is located beneath the solar cell such that increased heat from solar radiation warms the insect repellant within the insect repellant chamber to circulate fumes generated by the insect repellent via convection.

20. A weather measurement instrument sensor comprising:
a housing having a top surface, a bottom surface, and a sidewall that at least partially define an interior volume within the housing;
a first arm coupled to the housing and rotatable relative to the housing between a stowed position and a use position;
a second arm spaced apart from the first arm, coupled to the housing, and rotatable relative to the housing between a stowed position and a use position;
a wind direction vane coupled to a distal end of the first arm to facilitate measurement of a wind direction;
an anemometer coupled to a distal end of the second arm to facilitate measurement of a wind speed;
a temperature and humidity chamber including a temperature sensor, a humidity sensor, and a fan configured to generate an airflow across the temperature sensor and the humidity sensor;
a water funnel coupled to the top surface of the housing, the water funnel configured to direct a collected rainfall to a rain tipping bucket positioned within the interior volume of the housing;
an insect repellant chamber formed within the housing, wherein the insect repellant chamber is configured to hold an insect repellant therein; and
wherein the first arm is rotatable relative to the housing about a first axis, wherein the second arm is rotatable relative to the housing about a second axis, and wherein the first axis is parallel to the second axis, and
wherein the housing includes an upper housing coupled to and separable from a lower housing, wherein the upper housing defines the top surface, wherein the lower housing defines the bottom surface, and wherein the sidewall includes a sidewall of the upper housing extending downward from the top surface and a sidewall of the lower housing extending upward from the bottom surface, wherein the sidewall of the upper housing and the sidewall of the lower housing are nested to overlap one another.
